(19) United States
(12) Patent Application Publication
(10) Pub. No.: US 2018/0120489 A1
(43) Pub. Date: May 3, 2018

(54) POLARIZER PRODUCTION METHOD

(71) Applicant: NITTO DENKO CORPORATION, Ibaraki-shi, Osaka (JP)

(72) Inventors: Masahiro Yaegashi, Ibaraki-shi (JP); Yuki Nakano, Ibaraki-shi (JP); Makiko Shinchi, Ibaraki-shi (JP)

(73) Assignee: NITTO DENKO CORPORATION, Ibaraki-shi, Osaka (JP)

(21) Appl. No.: 15/572,252

(22) PCT Filed: May 12, 2016
(86) PCT No.: PCT/JP2016/064124

§ 371 Date: Nov. 7, 2017

(30) Foreign Application Priority Data
May 13, 2015 (JP) 2015-098236
May 13, 2015 (JP) 2015-098237
May 12, 2016 (JP) 2016-095739

(51) Int. Cl. G02B 5/30; C08J 7/02; C08J 7/12; G02B 1/08; B05D 1/18

(52) U.S. Cl. CPC G02B 5/3025; C08J 7/02; B05D 1/18; G02B 1/08; C08J 7/12

(57) ABSTRACT

A method is provided to produce a polarizer having non-polarization portion that can achieve the multi-functionalization and high-functionalization of an electronic device, such as an image display apparatus, the method enabling high-precision and easy production of a desired non-polarization portion shape. The method of producing a polarizer of the present invention includes bringing, under a state in which a resin film containing a dichromatic substance is covered with a surface protective film so that at least part thereof is exposed, a basic solution into contact with the exposed portion. In one embodiment, the exposed portion is subjected to a surface modification treatment at a time of the contact. In one embodiment, a contact angle between the exposed portion and the basic solution is 50° or less.

### TECHNICAL FIELD

The present invention relates to a method of producing a polarizer, and more specifically, to a method of producing a polarizer having a non-polarization portion.

### BACKGROUND ART

Some of the image display apparatus of a cellular phone, a notebook personal computer (PC), and the like have mounted thereon internal electronic parts, such as a camera. Various investigations have been made for the purpose of improving, for example, the camera performance of any such image display apparatus (for example, Patent Literatures 1 to 6). However, an additional improvement in camera performance or the like has been desired in association with rapid widespread use of a smart phone and a touch panel-type information processing apparatus. In addition, a polarizing plate partially having polarization performance has been required in order to correspond to the diversification of the shapes of the image display apparatus and the high-functionalization thereof. In order to industrially and commercially achieve those requirements, the production of the image display apparatus and/or parts thereof at acceptable cost has been demanded. However, there still remain various items to be investigated for establishing such technology.

### CITATION LIST

### Patent Literature

[PTL 1] JP 2011-81315 A

[PTL 2] JP 2007-241314 A

[PTL 3] US 2004/0212555 A1

[PTL 4] KR 10-2012-0118205 A

[PTL 5] KR 10-1293210 B1

[PTL 6] JP 2012-137738 A

### SUMMARY OF INVENTION

### Technical Problem

The present invention has been made to solve the conventional problems, and a primary object of the present invention is to provide a method of producing a polarizer that can achieve the multi-functionalization and high-functionalization of an electronic device, such as an image display apparatus, the method enabling high-precision and easy production of a desired non-polarization portion shape.

### Solution to Problem

The inventors of the present invention have adopted a production method including bringing, under a state in which a resin film containing a dichromatic substance (hereinafter sometimes referred to as “resin film”) is covered with a surface protective film so that at least part thereof is exposed, a basic solution into contact with the exposed portion, and have found that the object can be achieved by subjecting the exposed portion to a surface modification treatment at the time of the contact and/or setting a contact angle between the exposed portion and the basic solution to 50° or less. Thus, the inventors have completed the present invention.

A method of producing a polarizer according to an embodiment of the present invention includes: bringing, under a state in which a resin film containing a dichromatic substance is covered with a surface protective film so that at least part thereof is exposed, a basic solution into contact with the exposed portion, wherein the exposed portion is subjected to a surface modification treatment at a time of the contact.

In one embodiment of the present invention, the method of producing a polarizer further includes subjecting the resin film covered with the surface protective film to the surface modification treatment.

In one embodiment of the present invention, the surface modification treatment includes a corona treatment.

In one embodiment of the present invention, the surface modification treatment includes application of a surface modifier.

In one embodiment of the present invention, the surface modifier includes an organosilane compound.

In one embodiment of the present invention, a contact angle between the exposed portion and the basic solution is 50° or less.

A method of producing a polarizer according to another embodiment of the present invention includes bringing, under a state in which a resin film containing a dichromatic substance is covered with a surface protective film so that at least part thereof is exposed, a basic solution into contact with the exposed portion, wherein a contact angle between the exposed portion and the basic solution is 50° or less.

In one embodiment of the present invention, the basic solution further contains an additive.

In one embodiment of the present invention, the contact is performed by immersing, under a state in which a surface of the resin film opposite to the surface protective film is covered with another surface protective film, the resin film in the basic solution while conveying the resin film.

According to another aspect of the present invention, there is provided a polarizer. The polarizer has a non-polarization portion having a circular shape and having a diameter of 2.9 mm or less.

In one embodiment of the present invention, the non-polarization portion has a circularity of 0.060 mm or less.

### Advantageous Effects of Invention

The production method of the present invention includes bringing, under a state in which a resin film containing a dichromatic substance is covered with a surface protective film so that at least part thereof is exposed, a basic solution into contact with the exposed portion. In one embodiment, at the time of the contact, the exposed portion is subjected to a surface modification treatment. In another embodiment, a contact angle between the exposed portion and the basic solution is 50° or less. In the production method of the present invention, a non-polarization portion is formed by bringing the basic solution into contact with the exposed portion. Depending on a shape that the exposed portion (as a result, the non-polarization portion) is desired to have, the basic solution cannot be sufficiently brought into contact with the exposed portion in some cases. For example, when a polarizer having a non-polarization portion having a complicated shape and/or a small size is produced, the basic solution cannot be sufficiently brought into contact with the resin film particularly in an end portion of the exposed portion in some cases owing to the surface tension of the basic solution. According to the invention of the application, such configuration as described above is adopted, and hence when the basic solution is brought into contact with the exposed portion, the basic solution can be sufficiently caused to permeate up to the end portion of the exposed portion. Accordingly, a non-polarization portion having a desired shape can be formed with high precision and ease. Further, when such configuration as described above (in particular, the surface modification treatment) is adopted, such excellent effect as described above can be achieved without the addition of an additive (e.g., an organic solvent, such as an alcohol) to the basic solution. As a result, a polarizer having a non-polarization portion having a desired shape can be produced without the arrangement of a drainage facility for the additive (e.g., the organic solvent). Therefore, the production method of the present invention is preferred from the viewpoints of a cost reduction in a production facility and environmental consideration.

### BRIEF DESCRIPTION OF DRAWINGS

FIG. 1 is a schematic sectional view of a polarizing film laminate to be used in one embodiment of the present invention.

FIG. 2 are images for showing the states of the non-polarization portions of polarizers obtained in Examples 1 to 3 and Comparative Examples 1 and 2.

FIG. 3 is a graph for showing comparison between extents to which rejected products are produced in Example 3 and Comparative Example 2.

### DESCRIPTION OF EMBODIMENTS

Embodiments of the present invention are described below. However, the present invention is not limited to these embodiments.

A. Method of Producing Polarizer

A production method of the present invention includes bringing, under a state in which a resin film containing a dichromatic substance is covered with a surface protective film so that at least part thereof is exposed, a basic solution into contact with the exposed portion. A non-polarization portion is formed by bringing the basic solution into contact with the exposed portion. In one embodiment, there is used a polarizing film laminate including a resin film containing a dichromatic substance and a surface protective film arranged on one surface side of the resin film, the laminate having, on the one surface side, an exposed portion in which the resin film containing the dichromatic substance is exposed.

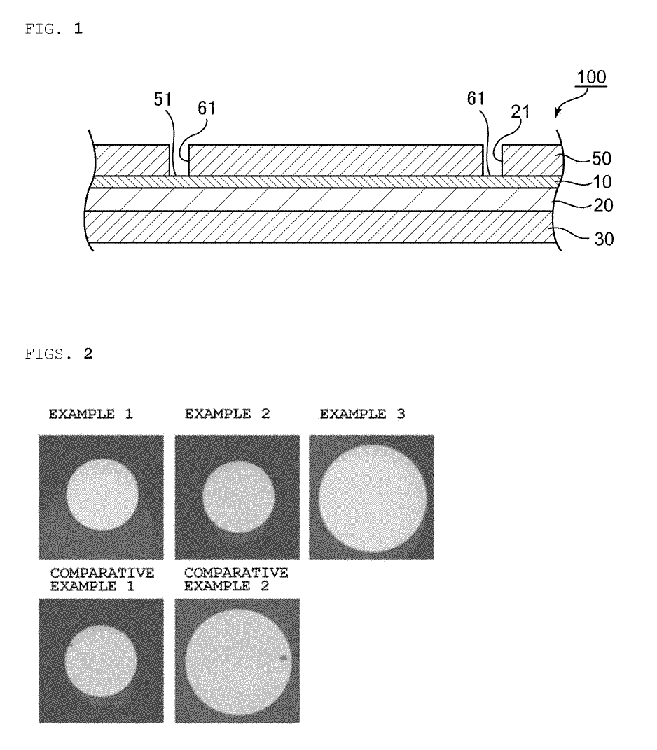

FIG. 1 is a schematic sectional view of a polarizing film laminate to be used in one embodiment of the present invention. In a polarizing film laminate 100, a surface protective film 50 is peelably laminated on a resin film 10 containing a dichromatic substance. The surface protective film 50 has through-holes 61. The polarizing film laminate 100 has exposed portions 51 in which the resin film 10 is exposed from the through-holes 61. The surface protective film 50 is peelably laminated on the resin film 10 through intermediation of any appropriate pressure-sensitive adhesive. In one embodiment, the surface protective film may be provided as a laminate with a pressure-sensitive adhesive layer. In this case, for convenience, the surface protective film in the laminate may be referred to as “substrate film”. In the illustrated example, in the resin film 10, a protective film 20 is laminated on a surface on which the surface protective film 50 is not laminated. The protective film 20 may be used as it is as a protective film for a polarizing plate to be described later. In the polarizing film laminate 100, another surface protective film 30 may be peelably laminated on the surface on which the surface protective film 50 having the through-holes is not laminated (in the illustrated example, the outside of the protective film 20).

The polarizing film laminate is typically elongated. When the elongated polarizing film laminate is used, for example, the step of bringing the exposed portion into contact with the basic solution and a step of bringing the exposed portion into contact with any other treatment liquid (e.g., a step of bringing the exposed portion into contact with an acidic solution) can be continuously performed by immersion. As a result, the productivity of the polarizer may be further improved.

(Resin Film Containing a Dichromatic Substance)

The resin film containing the dichromatic substance is a film which can be used as a polarizer. Examples of the dichromatic substance include iodine and an organic dye. The substances may be used alone or in combination. Of those, iodine is preferably used. This is because of the following reason: when a basic solution is brought into contact with the resin film as described later, an iodine complex is reduced and the content of iodine become lower, and as a result, a non-polarization portion having such characteristics as to be proper for use as a portion corresponding to camera can be formed.

Any appropriate resin may be used as a resin for forming the resin film. A polyvinyl alcohol-based resin (hereinafter referred to as “PVA-based resin”) is preferably used as the resin. Examples of the PVA-based resin include polyvinyl alcohol and an ethylene-vinyl alcohol copolymer. The polyvinyl alcohol is obtained by saponifying polyvinyl acetate. The ethylene-vinyl alcohol copolymer is obtained by saponifying an ethylene-vinyl acetate copolymer. The saponification degree of the PVA-based resin is typically 85 mol % or more and less than 100 mol %, preferably from 95.0 mol % to 99.95 mol %, more preferably from 99.0 mol % to 99.93 mol %. The saponification degree may be determined in conformity with JIS K 6726-1994. The use of the PVA-based resin having such saponification degree can provide a polarizer excellent in durability. When the saponification degree is too high, there is a risk of gelation.

The average polymerization degree of the PVA-based resin may be appropriately selected depending on purposes. The average polymerization degree is typically from 1,000 to 10,000, preferably from 1,200 to 4,500, more preferably from 1,500 to 4,300. The average polymerization degree may be determined in conformity with JIS K 6726-1994.

The thickness of the resin film containing the dichromatic substance may be set to any appropriate value. The thickness is preferably 30 μm or less, more preferably 25 μm or less, still more preferably 20 μm or less, particularly preferably less than 10 μm. The thickness is preferably 0.5 μm or more, more preferably 1 μm or more. By setting the thickness above range, the non-polarization portion can be more satisfactorily formed by bringing the basic solution into contact with the exposed portion. Further, the time period for which the exposed portion and the basic solution are brought into contact with each other makes shorter. In addition, the thickness of the portion with which the basic solution is brought into contact may be smaller than that of another portion. When the thickness of the resin film is small, a difference in thickness between the portion brought into contact with the basic solution and another portion can be reduced, and hence the bonding of the polarizer to any other constituent member, such as a protective film, can be satisfactorily performed.

As mentioned above, the resin film containing the dichromatic substance is a film which can be used as a polarizer. Specifically, the resin film is preferably subjected to various treatments, such as a swelling treatment, a stretching treatment, a dyeing treatment with the dichromatic substance, a cross-linking treatment, a washing treatment, and a drying treatment, to be brought into a state in which the resin film can function as a polarizer. When the resin film is subjected to the various treatments, the resin film may be a resin layer formed on a substrate. A laminate of the substrate and the resin layer can be obtained by, for example, a method involving applying an application liquid containing a material for forming the resin film to the substrate, or a method involving laminating the resin film on the substrate.

The dyeing treatment is performed, for example, by immersing the resin film into the dyeing liquid. An aqueous solution of iodine is preferably used as the dyeing liquid. The compounding amount of iodine is preferably from 0.04 part by weight to 5.0 parts by weight with respect to 100 parts by weight of water. The aqueous solution of iodine is preferably compounded with an iodide in order that the solubility of iodine in water may be increased. Potassium iodide is preferably used as the iodide. The compounding amount of the iodide is preferably from 0.3 part by weight to 15 parts by weight with respect to 100 parts by weight of water.

In the stretching treatment, typically, the resin film is uniaxially stretched at from 3 times to 7 times. A stretching direction can correspond to the absorption axis direction of the polarizer to be obtained.

(Surface Protective Film)

The surface protective film is used for the purpose of temporarily protecting the resin film in the step of bringing the basic solution into contact with the exposed portion to be described later. Therefore, the surface protective film is clearly distinguished from a protective film for the polarizer (e.g., the protective film 20 in the illustrated example). For example, the surface protective film has formed therein a through-hole corresponding to a portion corresponding to a desired non-polarization portion shape (specifically, a portion corresponding to the exposed portion). In one embodiment, the surface protective film is a laminate having a substrate film formed of any appropriate resin and a pressure-sensitive adhesive layer arranged on one surface of the substrate film, and has a through-hole penetrating the substrate film and the pressure-sensitive adhesive layer.

Any appropriate formation material may be used as a formation material for the substrate film. Examples thereof include: polyester-based resins, such as a polyethylene terephthalate-based resin; cycloolefin-based resins, such as a norbornene-based resin; olefin-based resins, such as polyethylene and polypropylene; polyamide-based resins; polycarbonate-based resins; and copolymer resins thereof. In one embodiment, polyester-based resins (in particular, a polyethylene terephthalate-based resin) are preferred. Any such material has the following advantage: in the case where the substrate film is used in an elongated polarizing film laminate, its modulus of elasticity is so high that the deformation of the through-hole hardly occurs even when tension is applied at the time of its conveyance and/or bonding.

The thickness of the substrate film may be set to any appropriate value. For example, the thickness of the substrate film may be from 30 μm to 150 μm because the following advantage is obtained: in the case where the substrate film is used in an elongated polarizing film laminate, the deformation of the through-hole hardly occurs even when tension is applied at the time of its conveyance and/or bonding. In the production method of the present invention, even when a thicker substrate film is used, a non-polarization portion having a desired shape can be formed with high precision.

The modulus of elasticity of the substrate film is preferably from 2.2 kN/mm² to 4.8 kN/mm². When the modulus of elasticity of the substrate film falls within such range, for example, the following advantage is obtained: in the case where the substrate film is used in an elongated polarizing film laminate, the deformation of the through-hole hardly occurs even when tension is applied at the time of its conveyance and/or bonding. The modulus of elasticity is measured in conformity with JIS K 6781.

The tensile elongation of the substrate film is preferably from 90% to 170%. When the tensile elongation of the substrate film falls within such range, for example, the following advantage is obtained: in the case where the substrate film is used in an elongated polarizing film laminate, the substrate film hardly ruptures during its conveyance. The tensile elongation is measured in conformity with JIS K 6781.

Any appropriate pressure-sensitive adhesive may be adopted as a pressure-sensitive adhesive forming the pressure-sensitive adhesive layer as long as the effects of the present invention are obtained. A base resin for the pressure-sensitive adhesive is, for example, an acrylic resin, a styrene-based resin, or a silicone-based resin. Of those, an acrylic resin is preferred from the viewpoints of, for example, chemical resistance, adhesiveness for preventing the infiltration of a treatment liquid at the time of the immersion, and a degree of freedom to an adherend. In addition, the pressure-sensitive adhesive may contain a cross-linking agent, and examples of the cross-linking agent that may be incorporated into the pressure-sensitive adhesive include an isocyanate compound, an epoxy compound, and an aziridine compound. The pressure-sensitive adhesive may contain, for example, a silane coupling agent. The compounding formulation of the pressure-sensitive adhesive may be appropriately set in accordance with purposes.

The pressure-sensitive adhesive layer may be formed by any appropriate method. Specific examples thereof include a method involving applying a pressure-sensitive adhesive solution onto a substrate film and drying, and a method involving forming a pressure-sensitive adhesive layer onto a separator and transferring the pressure-sensitive adhesive layer to a substrate film. Examples of the application method include a roll coating method, such as reverse coating or gravure coating, a spin coating method, a screen coating method, a fountain coating method, a dipping method, and a spray method.

The thickness of the pressure-sensitive adhesive layer is preferably from 5 μm to 60 μm, more preferably from 5 μm to 30 μm. When the thickness is excessively small, a pressure-sensitive adhesive property becomes insufficient and hence air bubbles and the like may enter a pressure-sensitive adhesive interface. When the thickness is excessively large, an inconvenience, such as the protrusion of the pressure-sensitive adhesive, is liable to occur. When the surface protective film is the laminate with the pressure-sensitive adhesive layer, the thickness of the pressure-sensitive adhesive layer may be adjusted within an appropriate range in accordance with the thickness of the substrate film.

Any appropriate shape may be adopted as the plan-view shape of the through-hole of the surface protective film in accordance with purposes. Specific examples thereof include a circular shape, an elliptical shape, a square, a rectangle, and a rhombus. As described above, according to the production method of the present invention, a non-polarization portion having a desired shape can be formed with high precision. Accordingly, the shape of the through-hole of the surface protective film may be a more complicated shape (e.g., a star shape).

In one embodiment, the through-hole of the surface protective film may have a smaller size. For example, when a circular through-hole is arranged, its diameter may be 2.9 mm or less.

The through-hole of the surface protective film can be formed by, for example, mechanical punching (e.g., punching, chisel punching, a plotter, or a water jet) or the removal of a predetermined portion of the surface protective film (e.g., laser ablation or chemical dissolution).

As described above, in the polarizing film laminate, another surface protective film (specifically, the surface protective film 30 of FIG. 1) may be further laminated on a side on which the above-mentioned surface protective film is not arranged. The other surface protective film is formed of any appropriate formation material. For example, a formation material for the above-mentioned surface protective film may be used, or any other resin, such as polyolefin (e.g., polyethylene), may be used. When the other surface protective film is used, the resin film can be more appropriately protected in the step of bringing the basic solution into contact with the exposed portion. As a result, the non-polarization portion can be more satisfactorily formed. As in the above-mentioned surface protective film, the other surface protective film may be laminated on the polarizing film laminate (in the illustrated example, the protective film 20) through intermediation of any appropriate pressure-sensitive adhesive, or may be provided as a laminate of a substrate film and a pressure-sensitive adhesive layer.

(Contact of Basic Solution)

When the basic solution is brought into contact with the resin film (specifically, the exposed portion), the resin film is decolored and the non-polarization portion can be formed by the decoloring. As described above, a resin film containing iodine is preferably used as the resin film containing the dichromatic substance. When the resin film contains iodine as the dichromatic substance, an iodine content is reduced by bringing the basic solution into contact with the exposed portion, and as a result, the non-polarization portion can be selectively formed only in the exposed portion. Accordingly, the non-polarization portion can be selectively formed in a desired portion of the resin film with extremely high production efficiency without any complicated operation. In the case where iodine remains in the non-polarization portion, even when the non-polarization portion is formed by breaking an iodine complex, there is a risk in that the iodine complex is formed again in association with the use of the polarizer, and hence the non-polarization portion does not have desired characteristics. In this embodiment, the content of iodine itself is low and hence the transparency of the non-polarization portion is satisfactorily maintained as compared to the case where the non-polarization portion is formed by decomposing the iodine complex with laser light or the like.

The formation of the non-polarization portion with the basic solution is described in more detail. After having been brought into contact with the exposed portion, the basic solution permeates the inside of the exposed portion. The iodine complex in the exposed portion is reduced by a base in the basic solution to become an iodine ion. When the iodine complex is reduced to the iodine ion, the polarization performance of the exposed portion substantially disappears and hence the non-polarization portion is formed in the exposed portion. In addition, the reduction of the iodine complex increases the transmittance of the exposed portion. Iodine that has become the iodine ion moves from the exposed portion to the solvent of the basic solution. Thus, the non-polarization portion is selectively formed in a predetermined portion of the resin film, and the non-polarization portion becomes stable even under a humidified condition. The permeation of the basic solution up to an undesired portion (as a result, the formation of the non-polarization portion in the undesired portion) can be prevented by adjusting, for example, a formation material for, and the thickness and mechanical characteristics of, the surface protective film, the concentration of the basic solution, and the time period for which the basic solution is brought into contact with the exposed portion.

The step of bringing the basic solution into contact with the exposed portion may be performed by any appropriate means. Examples thereof include the dropping, application, and spraying of the basic solution, and immersion in the basic solution. As described above, when the surface protective film is used, the content of the dichromatic substance does not reduce in a portion except the exposed portion, and hence the non-polarization portion can be formed only in the desired portion by the immersion in the basic solution. The immersion in the basic solution is preferably performed as follows: an elongated polarizing film laminate in which the above-mentioned surface protective film is laminated on one side of the above-mentioned resin film and the above-mentioned other surface protective film is laminated on the other side thereof is used, and the polarizing film laminate is immersed in the basic solution while being conveyed. Thus, a continuous treatment can be performed while the laminate is conveyed with a roll, and hence a polarizer having a non-polarization portion can be produced at low cost and with high productivity. In this case, however, the risk of the occurrence of a floating island-like defect in which a transmittance in the non-polarization portion locally reduces owing to the failure of a decoloring treatment becomes higher. However, the floating island-like defect can be effectively reduced by subjecting the exposed portion to a surface modification treatment at the time of the contact and/or setting a contact angle between the exposed portion and the basic solution to 50° or less (particularly preferably by subjecting the exposed portion to the surface modification treatment at the time of the contact) like the present invention.

Any appropriate basic compound may be used as the basic compound contained in the basic solution. Examples thereof include: hydroxides of alkali metals, such as sodium hydroxide, potassium hydroxide, and lithium hydroxide; hydroxides of alkaline earth metals, such as calcium hydroxide; inorganic alkali metal salts, such as sodium carbonate; organic alkali metal salts, such as sodium acetate; and ammonia water. Of those basic compounds, hydroxides of alkali metals are preferred, and sodium hydroxide, potassium hydroxide, and lithium hydroxide are more preferred. The use of a hydroxide of an alkali metal can efficiently ionize the iodine complex, and hence more simply forms a non-polarization portion. Those basic compounds may be used alone or in combination.

Any appropriate solvent may be used as the solvent of the basic solution. Specific examples thereof include water, alcohols, such as ethanol and methanol, ethers, benzene, chloroform, and mixed solvents thereof. The solvent is preferably water or an alcohol because the dichromatic substance can satisfactorily migrate to the solvent.

The concentration of the basic solution is, for example, from 0.01 N to 5 N, preferably from 0.05 N to 3 N, more preferably from 0.1 N to 2.5 N. When the concentration of the basic solution falls within such range, the amount of the dichromatic substance is reduced efficiently and reducing the amount of the dichromatic substance in the portion excluding the exposed portion can be prevented.

The liquid temperature of the basic solution is, for example, from 20° C. to 50° C. The time period for which the exposed portion and the basic solution are brought into contact with each other can be set in accordance with the thickness of the resin film, the kind of the basic compound contained in the basic solution, and the concentration of the basic solution, and is, for example, from 5 seconds to 30 minutes.

After the contact with the exposed portion (formation of the non-polarization portion), the basic solution can be removed by any appropriate means, as needed. A method for the removal of the basic solution is specifically, for example, removal by wiping with a waste cloth or the like, removal by suction, natural drying, heat drying, blow drying, vacuum drying or washing. When the basic solution is removed by drying, the drying temperature is, for example, from 20° C. to 100° C.

At the time of the contact, the exposed portion is subjected to the surface modification treatment. When the exposed portion is subjected to the surface modification treatment, the basic solution can easily wet and spread, and hence the non-polarization portion can be uniformly formed. As a result, a non-polarization portion having a desired shape can be formed with high precision. Further, when the exposed portion is subjected to the surface modification treatment, the non-polarization portion having the desired shape can be formed with high precision without the addition of an additive (e.g., an organic solvent, such as an alcohol) to the basic solution. As a result, a drainage facility for the additive (e.g., the organic solvent) can be omitted. Therefore, the production method of the present invention is preferred from the viewpoints of a cost reduction in a production facility and environmental consideration.

The surface modification treatment of the exposed portion is performed at any appropriate stage. The surface modification treatment of the resin film may be performed on the entirety of the resin film, or may be performed only on a desired portion (e.g., a portion corresponding to the exposed portion). In one embodiment, the surface modification treatment is performed on the exposed portion. Specifically, the surface modification treatment is performed on the exposed portion of the resin film covered with the surface protective film. In addition, in another embodiment, the surface modification treatment is performed on the entirety of the resin film. Specifically, the resin film subjected to the surface modification treatment is covered with the surface protective film. The resin film covered with the surface protective film is preferably subjected to the surface modification treatment because the desired portion can be easily subjected to the surface modification treatment.

Any appropriate method may be used as a method for the surface modification treatment. Examples thereof include a corona treatment, a plasma treatment, vacuum UV irradiation, and the application of a diluted liquid obtained by diluting a surface modifier, such as a silane coupling agent, with any appropriate solvent. The surface modification treatment is preferably the corona treatment or the application of the diluted liquid of the surface modifier.

The corona treatment may be performed under any appropriate condition. For example, a corona discharge electron irradiation amount is preferably from 10 W/m²/min to 500 W/m²/min, more preferably from 30 W/m²/min to 300 W/m²/min.

Any appropriate surface modifier may be used as the surface modifier. An example thereof is a silane coupling agent. An example of the silane coupling agent is an organosilane compound having at least one functional group selected from the group consisting of an epoxy group, an acrylic group, a methacrylic group, an amino group, an isocyanate group, and a mercapto group. The surface modifiers may be used alone or in combination thereof.

Specific examples of the organosilane compound having an epoxy group include 2-(3,4-epoxycyclohexyl)dichethyltrimethoxysilane, 3-glycidoxypropylmethyldimethoxysilane, 3-glycidoxypropyltrimethoxysilane, 3-glycidoxypropylmethyldiethoxysilane, and 3-glycidoxypropyltriethoxysilane. Examples of the organosilane compound having an acrylic group include 3-acryloxypropyltrimethoxysilane and 3-acryloxypropyltriethoxysilane. Examples of the organosilane compound having a methacrylic group include 3-methacryloxypropylmethyldimethoxysilane, 3-methacryloxypropyltrimethoxysilane, 3-methacryloxypropylmethyldiethoxysilane, and 3-methacryloxypropyltriethoxysilane. Examples of the organosilane compound having an amino group include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and N-(vinylbenzyl)-2-aminoethyl-3-aminopropyltrimethoxysilane. Examples of the organosilane compound having an isocyanate group include 3-isocyanatopropyltriethoxysilane and 3-isocyanatopropyltrimethoxysilane. Examples of the organosilane compound having a mercapto group include 3-mercaptopropylmethyldimethoxysilane and 3-mercaptopropyltrimethoxysilane.

A commercial product may be used as the silane coupling agent. Examples of the commercial product include “KBM Series” and “KBE Series” manufactured by Shin-Etsu Chemical Co., Ltd.

Any appropriate solvent may be used as the solvent. When, for example, the silane coupling agent is used, water, methanol, or ethanol may be suitably used. Any appropriate method may be used as the application method. Examples thereof include a roll coating method, such as reverse coating and gravure coating, a spin coating method, a screen coating method, a fountain coating method, a dipping method, and a spray method.

The content of the surface modifier in the diluted liquid may be set to any appropriate value. The content of the surface modifier is, for example, from 0.1 part by weight to 10 parts by weight, preferably from 1 part by weight to 5 parts by weight with respect to 100 parts by weight of the solvent. When the content of the surface modifier falls within the range, the exposed portion may have moderate wettability. When the content of the surface modifier is excessively small, a sufficient surface modification effect may not be obtained. In addition, when the content of the surface modifier is excessively large, an inconvenience may occur in the external appearance of the polarizer to be obtained.

In one embodiment, the contact angle between the exposed portion and the basic solution is 50° or less. When the contact angle is 50° or less, the basic solution can be sufficiently brought into contact with (caused to permeate) up to an end portion of the exposed portion. The contact angle between the exposed portion and the basic solution is preferably 40° or less, more preferably 35° or less. When the contact angle between the exposed portion and the basic solution falls within such range, an affinity between the exposed portion and the basic solution is further improved, and hence the basic solution can be more satisfactorily brought into contact with the exposed portion. The contact angle between the exposed portion and the basic solution may be measured with a contact angle meter at 25° C. by a drop method.

Any appropriate method may be used as a method of setting the contact angle between the exposed portion and the basic solution to 50° or less. Examples thereof include the surface modification of the resin film (e.g., the exposed portion) and the addition of any appropriate additive to the basic solution. Those methods may be used alone or in combination thereof.

The surface modification of the resin film is as described above as the surface modification treatment.

Any appropriate additive may be used as the additive to the basic solution, and is, for example, a surfactant. Examples of the surfactant include: anionic surfactants, such as a sodium alkyl sulfate and a sodium alkyl sulfonate; cationic surfactants, such as an alkyltrimethylammonium chloride and a dialkyldimethylammonium chloride; nonionic surfactants, such as a polyoxyethylene alkyl ether and a polyoxyethylene sorbitan fatty acid ester; and amphoteric surfactants. Of those, stearyltrimethylammonium chloride and cetyltrimethylammonium chloride are preferred. The contact angle can be more satisfactorily reduced through use of those surfactants. The surfactants may be used alone or in combination thereof.

The amount of the additive to be added to the basic solution may be set to any appropriate value so that the contact angle is 50° or less. The addition amount is, for example, from 0.1 part by weight to 10 parts by weight, preferably from 0.5 part by weight to 3 parts by weight with respect to 100 parts by weight of the solvent of the basic solution. When the addition amount is excessively small, the contact angle cannot be made sufficiently small in some cases. When the addition amount is excessively large, an inconvenience may occur in the external appearance of the polarizer to be obtained.

(Other Step)

The method of producing a polarizer of the present invention may further include any appropriate step except the step of bringing the basic solution into contact with the exposed portion. Examples of the other step include a step of bringing into contact with an acidic solution and a washing step.

The production method of the present invention may further include the step of bringing into contact with the acidic solution. When the method further includes the step of bringing into contact with the acidic solution, a non-polarization portion having desired dimensions can be stably maintained even under a humidified condition. The step of bringing into contact with the acidic solution may be performed, for example, after the step of bringing the exposed portion into contact with the basic solution.

Any appropriate acidic compound may be used as an acidic compound in the acidic solution. Examples of the acidic compound include inorganic acids, such as hydrochloric acid, sulfuric acid, nitric acid, and hydrogen fluoride, and organic acids, such as formic acid, oxalic acid, citric acid, acetic acid, and benzoic acid. The concentration of the acidic solution is, for example, from 0.01 N to 5 N, preferably from 0.05 N to 3 N, more preferably from 0.1 N to 2.5 N.

The same conditions as the conditions that may be adopted in the step of bringing the exposed portion into contact with the basic solution described above may be adopted for a solvent to be used in the acidic solution, the liquid temperature of the acidic solution, the time period for which is brought into contact with the acidic solution, and a method for the contact.

The production method of the present invention may further include the washing step. The washing step may be performed only once, or may be performed a plurality of times. The washing step may be performed at any appropriate stage of a production process for the polarizer. For example, the resin film brought into contact with the basic solution may be washed with any appropriate liquid and then brought into contact with the acidic solution, or the washing step with any appropriate liquid may be performed after the step of bringing into contact with the basic solution and the step of bringing into contact with the acidic solution have been performed.

Any appropriate solution can be used as a solution to be used in the washing treatment. Examples of a solution to be used in the washing treatment include pure water, alcohols, such as methanol and ethanol, an acidic aqueous solution, and mixed solvents thereof. The temperature of the solution to be used in the washing treatment may be set to any appropriate value.

B. Polarizer Having Non-Polarization Portion

A polarizer obtained by the method of the present invention may have a non-polarization portion that is formed with high precision, and has a desired shape and a desired size. Accordingly, the polarizer of the present invention may have excellent functionality and an excellent design property.

The polarizer having the non-polarization portion is applicable to, for example, an image display apparatus including a camera. This is because of the following reason: even when a non-polarization portion having a smaller size is formed, the camera can sufficiently exhibit a photographing function, and the appearance of the image display apparatus to be obtained may be excellent.

In one embodiment, the non-polarization portion has a circular shape and its diameter is 2.9 mm or less. Even when the polarizer of the present invention has a non-polarization portion having such small size, a desired shape can be formed with high precision.

When the non-polarization portion has a circular shape, the circularity of the non-polarization portion is preferably 0.060 mm or less, more preferably 0.030 mm or less. When the circularity falls within the range, the non-polarization portion is formed so as to be closer to a perfect circle and with high precision. Accordingly, for example, even when a smaller non-polarization portion is required as a camera portion, a reduction in camera performance in association with insufficient decoloring can be prevented. The circularity refers to a difference in radius between a concentric circle circumscribed on such a circle that the sum of the squares of deviations with respect to the shape of the non-polarization portion subjected to measurement becomes minimum and a concentric circle inscribed thereon (circularity based on a least-square center method).

Any appropriate shape may be adopted as the plan-view shape of the non-polarization portion as long as the camera performance of an image display apparatus is not adversely affected. In addition, the transmittance of the non-polarization portion (e.g., a transmittance measured with light having a wavelength of 550 nm at 23° C.) is preferably 50% or more, more preferably 60% or more, still more preferably 75% or more, particularly preferably 90% or more. With such transmittance, the non-polarization portion can secure desired transparency. As a result, when the polarizer is arranged so that the non-polarization portion corresponds to a camera portion of the image display apparatus, an adverse effect on the photographing performance of the camera can be prevented.

The non-polarization portion is preferably significantly suppressed in occurrence of a floating island-like defect, and is more preferably substantially free of any floating island-like defect. The term “floating island-like defect” refers to a portion in the non-polarization portion where a transmittance is low owing to a decoloring failure. The non-polarization portion has a minimum relative transmittance out of relative transmittances measured for each pixel (typically measuring 5 μm by 5 μm) of, for example, 60.0% or more, preferably 65.0% or more. In addition, the rate of occurrence of floating island-like defects in the non-polarization portion is, for example, 0.8% or less. The term “relative transmittance” as used herein refers to a transmittance obtained as follows: the average brightness of a decolored portion (the non-polarization portion) is defined as 100%, the average brightness of a non-decolored portion (a portion except the non-polarization portion) is defined as 0%, and the non-polarization portion is displayed in a 256-level gray scale and the brightness is converted into a transmittance. A surface modification treatment is effective for the suppression of floating island-like defects, and a corona treatment can be particularly effective.

C. Polarizing Plate

The polarizer may be practically provided as a polarizing plate. The polarizing plate has the polarizer and a protective film arranged on at least one side of the polarizer. Practically, the polarizing plate has a pressure-sensitive adhesive layer as an outermost layer. The pressure-sensitive adhesive layer typically serves as an outermost layer on an image display apparatus side. A separator may be peelably temporarily bonded to the pressure-sensitive adhesive layer.

As formation materials for the protective film, there are given, for example, a cellulose-based resin, such as diacetyl cellulose or triacetyl cellulose, a (meth)acrylic resin, a cycloolefin-based resin, an olefin-based resin, such as polypropylene, an ester-based resin, such as a polyethylene terephthalate-based resin, a polyamide-based resin, a polycarbonate-based resin, and copolymer resins thereof. The thickness of the protective film is preferably from 10 μm to 100 μm. The protective film is typically laminated on the polarizer through intermediation of an adhesion layer (specifically an adhesive layer or a pressure-sensitive adhesive layer). The adhesive layer is typically formed of a PVA-based adhesive or an active energy ray-curable adhesive. The pressure-sensitive adhesive layer is typically formed of an acrylic pressure-sensitive adhesive.

The polarizing plate may further have any appropriate optical functional layer in accordance with purposes. Typical examples of the optical functional layer include a retardation film (optical compensation film) and a surface-treated layer. In addition, the protective film may have an optical compensation function (specifically, the film may have an appropriate refractive index ellipsoid, an appropriate in-plane retardation, and an appropriate thickness direction retardation in accordance with purposes).

The surface-treated layer may be arranged on the viewer side of the polarizing plate. Typical examples of the surface-treated layer include a hard coat layer, an antireflection layer, and an antiglare layer.

D. Image Display Apparatus

An image display apparatus of the present invention includes the polarizer. Examples of the image display apparatus include a liquid crystal display apparatus and an organic EL device. Specifically, the liquid crystal display apparatus includes a liquid crystal panel including: a liquid crystal cell; and the polarizer arranged on one side, or each of both sides, of the liquid crystal cell. The organic EL device includes an organic EL panel including the polarizer arranged on a viewer side. The polarizer is arranged so that its non-polarization portion may correspond to the camera portion of an image display apparatus on which the polarizer is mounted.

### EXAMPLES

Now, the present invention is specifically described by way of Examples. However, the present invention is not limited to these Examples. Evaluation methods used in Examples are as described below.

### [Circularity]

A circularity was measured by a least-square center method. An ultra high-speed, flexible image processing system (manufactured by Keyence Corporation, product name: XG-7500) was used in the measurement. A non-polarization portion of a polarizer was photographed with a camera (measurement distance: 250 mm, measurement angle: 90°). An edge was detected from the photographed image and a circle (hereinafter sometimes referred to as “approximate circle of the non-polarization portion”) was drawn. Next, perfect circles (an inscribed circle and a circumscribed circle) tangent to the approximate circle of the non-polarization portion, and their centers were calculated by using a least-squares method. A distance from the center of each of the perfect circles thus calculated to the circumference of the approximate circle of the non-polarization portion (specifically, a radius) was measured, and a difference between a portion where the distance became maximum and a portion where the distance became minimum (circularity) was calculated. When the circularity is 0.060 mm or less, the polarizer can be suitably used in an application, such as an image display apparatus.

### [Minimum Relative Transmittance in Non-Polarization Portion (Evaluation for Floating Island-Like Defect)]

An inscribed circle was drawn by using the centers and minimum radii of the circles calculated in the circularity measurement. Next, a relative transmittance was calculated by: defining an average brightness value for the polarizer portion and an average brightness value in the inscribed circle as 0% and 100%, respectively; and determining a brightness value in the inscribed circle for each pixel (measuring about 5 μm by about 5 μm). The lowest relative transmittance in the inscribed circle was defined as a minimum relative transmittance. Typically, when a portion has a minimum relative transmittance of less than 60.0%, the portion may be recognized as a floating island-like defect.

### Example 1

A circular through-hole having a diameter of 1.9 mm was arranged in a resin film with a pressure-sensitive adhesive (PET resin film, thickness: 38 μm, thickness of a pressure-sensitive adhesive layer: 5 μm) by using a pinnacle blade. Thus, a surface protective film having a through-hole was obtained. The resultant surface protective film was bonded to the polarizer side surface of a polarizing plate having a total thickness of 30 μm (polarizer (transmittance: 42.3%, thickness: 5 μm)/protective film (thickness: 25 μm)) through intermediation of the pressure-sensitive adhesive layer. Thus, a polarizing film laminate was obtained.

An exposed portion of the resultant polarizing film laminate was subjected to a corona discharge treatment (corona discharge electron irradiation amount: 100 W/m²/min) with a table-type corona treatment apparatus (manufactured by KASUGA DENKI, Inc.). After the corona discharge treatment, a contact angle between the exposed portion and water was measured by a drop method with a contact angle meter (manufactured by Kyowa Interface Science Co., Ltd.). A measured value for the contact angle was 28°.

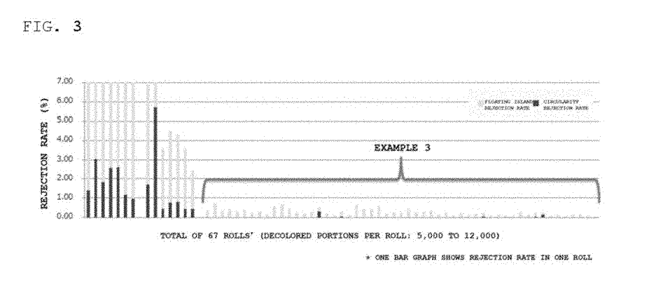

Next, a basic solution (aqueous solution of sodium hydroxide, 0.1 mol/L (0.1 N)) at normal temperature was dropped onto the exposed portion of the polarizing film laminate, and was left to stand for 1 minute. Next, the dropped aqueous solution of sodium hydroxide was removed with waste cloth. Thus, a polarizer having a non-polarization portion was obtained. The circularity and minimum relative transmittance of the non-polarization portion of the resultant polarizer were measured. The results are shown in Table 1. Further, an image for showing the state of the non-polarization portion is shown in FIG. 2.

### Example 2

A diluted liquid was obtained by mixing 1 part by weight of a silane coupling agent (manufactured by Shin-Etsu Chemical Co., Ltd., product name: KBM-303) with 99 parts by weight of a solvent (ethanol). A polarizer having a non-polarization portion was obtained in the same manner as in Example 1 except that instead of the corona treatment, the resultant diluted liquid was applied to the exposed portion and dried. After the application and drying of the diluted liquid, a contact angle between the exposed portion and water was measured by a drop method with a contact angle meter (manufactured by Kyowa Interface Science Co., Ltd.). The contact angle between the exposed portion and water was 45°.

The circularity and minimum relative transmittance of the non-polarization portion of the resultant polarizer were measured. The results are shown in Table 1. Further, an image for showing the state of the non-polarization portion is shown in FIG. 2.

### Example 3

A circular through-hole having a diameter of 2.8 mm was arranged in an elongated resin film with a pressure-sensitive adhesive (PET resin film, thickness: 38 μm, thickness of a pressure-sensitive adhesive layer: 5 μm) by using a pinnacle blade. In addition, the elongated resin film with a pressure-sensitive adhesive was used as it was as another surface protective film. The surface protective film was bonded to the polarizer side surface of an elongated polarizing plate having a total thickness of 30 μm (polarizer (transmittance: 42.3%, thickness: 5 μm)/protective film (thickness: 25 μm)) by a roll-to-roll process, and the other surface protective film was bonded to the protective film side surface of the polarizing plate by the roll-to-roll process. Thus, an elongated polarizing film laminate was obtained.

An exposed portion of the resultant elongated polarizing film laminate was subjected to a corona discharge treatment (corona discharge electron irradiation amount: 120 W/m²/min) with a table-type corona treatment apparatus (manufactured by KASUGA DENKI, Inc.) while the laminate was conveyed. After the corona discharge treatment, a contact angle between the exposed portion and water was measured by a drop method with a contact angle meter (manufactured by Kyowa Interface Science Co., Ltd.). A measured value for the contact angle was 32°.

Next, the polarizing film laminate with the resin film with a pressure-sensitive adhesive directed downward was immersed (15 seconds) in a basic solution (aqueous solution of sodium hydroxide, 2 mol/L (2 N)) at normal temperature while being conveyed. Next, the adhering aqueous solution of sodium hydroxide was washed off, and the remainder was dried. Thus, a polarizer having a non-polarization portion was obtained. The circularity and minimum relative transmittance of the non-polarization portion of the resultant polarizer were measured. The results are shown in Table 1. Further, an image for showing the state of the non-polarization portion is shown in FIG. 2.

In addition, a rejection rate when 53 rolls (elongated polarizing film laminates) were continuously produced under the same conditions is shown in FIG. 3 together with the result of Comparative Example 2. A product having a circularity of 0.040 mm or more, or having a minimum relative transmittance of less than 60.0% was judged to be a rejected product.

### Comparative Example 1

A polarizer having a non-polarization portion was obtained in the same manner as in Example 1 except that no surface modification treatment was performed on the exposed portion. A contact angle between the untreated exposed portion and water was 62°. The circularity and minimum relative transmittance of the non-polarization portion of the resultant polarizer were measured. The results are shown in Table 1. Further, an image for showing the state of the non-polarization portion is shown in FIG. 2.

### Comparative Example 2

A polarizer having a non-polarization portion was obtained in the same manner as in Example 3 except that no surface modification treatment was performed on the exposed portion. A contact angle between the untreated exposed portion and water was 63°.

The circularity and minimum relative transmittance of the non-polarization portion of the resultant polarizer were measured. The results are shown in Table 1. Further, an image for showing the state of the non-polarization portion is shown in FIG. 2.

In addition, a rejection rate when 14 rolls (elongated polarizing film laminates) were continuously produced under the same conditions is shown in FIG. 3 together with the result of Example 3.

TABLE 1

| | | | Minimum |
|---|---|---|---|
| | Contact | | relative |
| | angle | Circularity | transmittance |
| | (°) | (mm) | (%) |
| Example 1 | 28 | 0.014 | 72.4 |
| Example 2 | 45 | 0.008 | 65.2 |
| Example 3 | 32 | 0.014 | 74.3 |
| Comparative | 62 | 0.087 | 73.4 |
| Example 1 | | | |
| Comparative | 63 | 0.015 | 5.6 |
| Example 2 | | | |

As is apparent from Table 1, it is found that according to each of the production methods of Examples of the present invention, a polarizer having a non-polarization portion excellent in both circularity and minimum relative transmittance (floating island-like defect) is obtained. Specifically, in each of Examples 1 and 2 in each of which the exposed portion was subjected to the surface modification treatment, and the step of bringing the exposed portion into contact with the basic solution was performed, a desired non-polarization portion was formed with high precision despite the fact that the diameter of the non-polarization portion was 1.9 mm, i.e., its size was small. Meanwhile, in Comparative Example 1 in which no surface modification treatment was performed and the step of bringing the exposed portion into contact with the basic solution was performed, the shape of the non-polarization portion became distorted, and was hence still scope for improvement. Further, as is apparent from comparison between Example 3 and Comparative Example 2, it is found that the performance of the surface modification treatment suppresses the floating island-like defects and significantly reduces the rejection rate.

### INDUSTRIAL APPLICABILITY

The polarizer of the present invention is suitably used in an image display apparatus (a liquid crystal display apparatus or an organic EL device) with a camera of, for example, a cellular phone, such as a smart phone, a notebook PC, or a tablet PC.

### REFERENCE SIGNS LIST

10 resin film
20 protective film
30 surface protective film
50 surface protective film
51 exposed portion
61 through-hole
100 polarizing film laminate

1. A method of producing a polarizer, comprising bringing, under a state in which a resin film containing a dichromatic substance is covered with a surface protective film so that at least part thereof is exposed, a basic solution into contact with the exposed portion, wherein the exposed portion is subjected to a surface modification treatment at a time of the contact.

2. The method of producing a polarizer according to claim 1, further comprising subjecting the resin film covered with the surface protective film to the surface modification treatment.

3. The method of producing a polarizer according to claim 1, wherein the surface modification treatment comprises a corona treatment.

4. The method of producing a polarizer according to claim 1, wherein the surface modification treatment comprises application of a surface modifier.

5. The method of producing a polarizer according to claim 4, wherein the surface modifier comprises an organosilane compound.

6. The method of producing a polarizer according to claim 1, wherein a contact angle between the exposed portion and the basic solution is 50° or less.

7. A method of producing a polarizer, comprising bringing, under a state in which a resin film containing a dichromatic substance is covered with a surface protective film so that at least part thereof is exposed, a basic solution into contact with the exposed portion, wherein a contact angle between the exposed portion and the basic solution is 50° or less.

8. The method of producing a polarizer according to claim 6, wherein the basic solution further contains an additive.

9. The method of producing a polarizer according to claim 1, wherein the contact is performed by immersing, under a state in which a surface of the resin film opposite to the surface protective film is covered with another surface protective film, the resin film in the basic solution while conveying the resin film.

10. A polarizer, comprising a non-polarization portion having a circular shape and having a diameter of 2.9 mm or less.

11. The polarizer according to claim 10, wherein the non-polarization portion has a circularity of 0.060 mm or less.
